(19) United States
(12) Patent Application Publication
(10) Pub. No.: US 2018/0128457 A1
(43) Pub. Date: May 10, 2018

(54) LED LIGHT

(71) Applicant: Angeled Co., Ltd., Shenzhen (CN)

(72) Inventors: Youqing LIANG, Shenzhen (CN); Jiao LIU, Shenzhen (CN); Linzhi WEN, Shenzhen (CN)

(73) Assignee: Angeled Co., Ltd., Shenzhen (CN)

(21) Appl. No.: 15/454,640

(22) Filed: Mar. 9, 2017

(30) Foreign Application Priority Data
Nov. 9, 2016 (CN) 201621211755.7

(51) Int. Cl. F21V 19/00; F21V 23/06

(52) U.S. Cl. CPC F21V 19/004; F21Y 2115/10; F21V 19/0015; F21V 23/06

(57) ABSTRACT

Disclosed in the present utility model is an LED light, comprising a light board and further comprising a connecting platform and an AC input end, wherein the connecting platform and the light board are snap-joined and conducting, and the AC input end is connected to the connecting platform in the direction perpendicular to the light board and conducting with the connecting platform. The light board and the connecting platform are fixed with a snap joint structure instead of tin soldering, and the AC input end is connected to the connecting platform in the direction perpendicular to the light board so that the three parts of the light board, the connecting platform and the AC input end of the LED light are convenient to assemble and disassemble and easy to maintain which are conducive to the reduction of use costs.

### CROSS-REFERENCE TO RELATED APPLICATIONS

This application claims the benefit of priority to Chinese Application No. 201621211755.7, filed Nov. 9, 2016, in the State Intellectual Property Office. All disclosures of the document named above are incorporated herein in their entireties by reference.

### TECHNICAL FIELD

The utility model relates to the technical field of LEDs, and more particularly, to an LED light.

Description of Related Art

Currently, conducting between an LED light board and an AC input end is basically realized through welding or screwing. The AC input end and the LED light board can be fixedly connected through welding, but when the joint between the AC input end and the LED light board has problems, the soldering tin usually needs to be melted by means of an electric soldering iron or other equipment; basically, ordinary families may not have such equipment for melting the soldering tin, so once such a problem occurs, the LED lights are mostly discarded which results in a huge waste. Although screwing between the AC input end and the LED light board overcomes the above problems, this connection mode brings difficulties to the assembling and disassembling of the AC input end and the LED light board.

Therefore, it is necessary to provide an LED light which is convenient to assemble and disassemble and easy to maintain.

### BRIEF SUMMARY OF THE INVENTION

The technical problem which the present utility model needs to solve is to provide an LED light which is convenient to assemble and disassemble and easy to maintain.

To solve the above technical problems, the technical solution adopted in the utility model is an LED light, comprising a light board and further comprising a connecting platform and an AC input end, wherein the connecting platform and the light board are snap-joined and conducting, and the AC input end is connected to the connecting platform in the direction perpendicular to the light board and conducting with the connecting platform.

Furthermore, the profile of the connecting platform is of a convex shape, the light board is provided with a through-hole having a cross-section slightly larger than that of the convex section of the connecting platform, and the convex section of the connecting platform is provided with snap joint portions used for preventing the convex section of the connecting platform from coming off from the through-hole.

Furthermore, the number of the snap joint portions is two or four.

Furthermore, the snap joint portions are provided on opposite sides of the convex section of the connecting platform.

Furthermore, the connecting platform is provided with a snap joint part, and the light board is provided with a snap joint seat adapted to the snap joint part.

Furthermore, the snap joint part comprises a base provided on the connecting platform and an I-shaped hook rotatably provided on the base; the snap joint seat is a linear slot.

Furthermore, the connecting platform comprises a main body and a pressure-resistant fragment provided on the main body and against the light board.

Furthermore, the AC input end and the pressure-resistant fragment are conducting.

Furthermore, the AC input end and the pressure-resistant fragment are screwed or snap-joined.

Furthermore, the material of the pressure-resistant fragment is copper.

The beneficial effects of the present utility model are as below: the light board and the connecting platform are fixed with a snap joint structure instead of tin soldering, and the AC input end is connected to the connecting platform in the direction perpendicular to the light board so that the three parts of the light board, the connecting platform and the AC input end of the LED light are convenient to assemble and disassemble and easy to maintain which are conducive to the reduction of use costs.

### BRIEF DESCRIPTION OF THE DRAWINGS

FIG. 1 is an overall-structure diagram of the LED light in Embodiment 1 of the present utility model;

FIG. 2 is an enlarged view of Detail A in FIG. 1;

FIG. 3 is an overall-structure diagram of the LED light in Embodiment 1 of the present utility model in another angle of view;

FIG. 4 is a sectional view of the connecting platform and the light board of the LED light in Embodiment 2 of the present utility model when assembled;

FIG. 5 is a sectional view of the connecting platform and the light board of the LED light in Embodiment 2 of the present utility model after assembling;

FIG. 6 is a top view of the connecting platform and the light board of the LED light in Embodiment 2 of the present utility model after assembling.

### SYMBOL DESCRIPTION

1—light board; 2—connecting platform; 3—AC input end; 4—snap joint part; 41—base; 42—hook; 5—linear slot; 6—convex section of the connecting platform; 7—snap joint portion.

### DETAILED DESCRIPTION OF THE INVENTION

The present utility model is further detailed in combination with the embodiments and drawings as follows to help better understand the technical content, objectives and effects of the utility model.

The most important concept of the present utility model is that the light board and the connecting platform are fixed with a snap joint structure instead of tin soldering and the AC input end is connected to the connecting platform in the direction perpendicular to the light board.

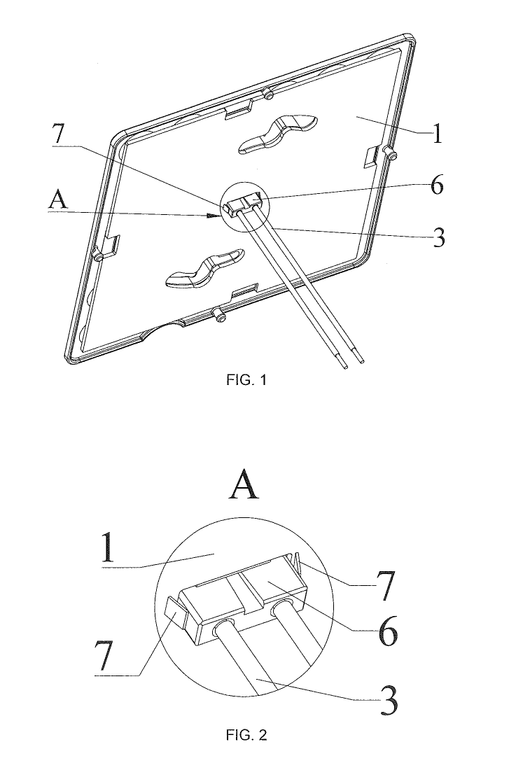

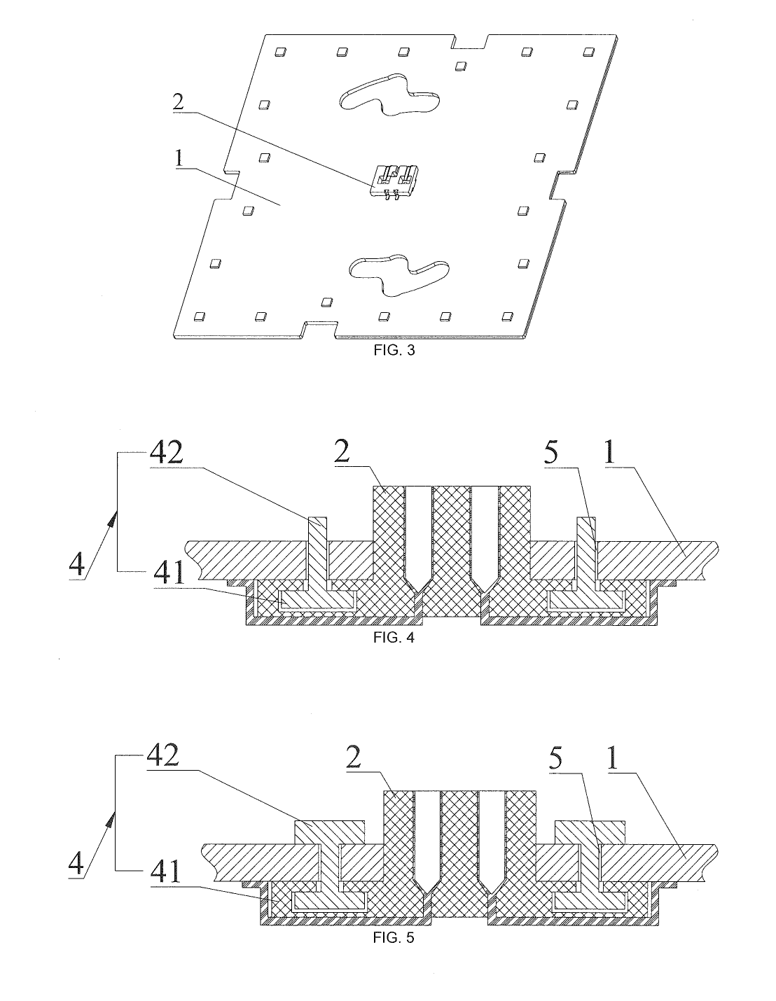

As shown in FIG. 1 to FIG. 6, an LED light, comprising a light board 1 and further comprising a connecting platform 2 and an AC input end 3, wherein the connecting platform 2 and the light board 1 are snap-joined and conducting, and the AC input end 3 is connected to the connecting platform 2 in the direction perpendicular to the light board 1 and conducting with the connecting platform 2.

As seen from the above description, the beneficial effects of the present utility model are as below: the light board and the connecting platform are fixed with a snap joint structure instead of tin soldering, and the AC input end is connected to the connecting platform in the direction perpendicular to the light board so that the three parts of the light board, the connecting platform and the AC input end of the LED light are convenient to assemble and disassemble and easy to maintain which is conducive to the reduction of use costs. Specifically, the snap-joint structure facilitates the assembling and disassembling of the light board and the connecting platform; the connection of the AC input end in the direction perpendicular to the light board makes it easier for workers to assemble and disassemble the AC input end.

Furthermore, the profile of the connecting platform 2 is of a convex shape, the light board 1 is provided with a through-hole having a cross-section slightly larger than the cross-section of the convex section 6 of the connecting platform, and the convex section 6 of the connecting platform is provided with snap joint portions 7 used for preventing the convex section 6 of the connecting platform from coming off from the through-hole.

As seen from the above description, the convex section of the connecting platform passes through the through-hole so that the light board is fixed between the horizontal section of the connecting platform and the snap joint parts by means of the snap joint parts, which can facilitate the disassembling of the connecting platform from the light board in the future.

Furthermore, the number of the snap joint portions 7 is two or four.

Furthermore, the snap joint portions 7 are provided on opposite sides of the convex section 6 of the connecting platform.

As seen from the above description, the snap joint portions are provided on opposite sides of the convex section, which can facilitate the disassembling of the connecting platform by users in that the connecting platform can be easily removed from the light board only when users press the snap joint portions.

Furthermore, the connecting platform is provided with a snap joint part 4, and the light board 1 is provided with a snap joint seat adapted to the snap joint part 4.

Furthermore, the snap joint part 4 comprises a base 41 provided on the connecting platform 2 and an I-shaped hook 42 rotatably provided on the base 41; the snap joint seat is a linear slot 5.

As seen from the above description, a rotary snap joint part can bring great convenience to the assembling and disassembling of the connecting platform. The procedures for assembling the connecting platform to the light board are as follows: the hook is aligned with the linear slot and partially passes through the linear slot, and the hook is rotated so that the portion of the hook passing through the through-hole is snap-joined with the light board, thus completing the assembling.

Furthermore, the connecting platform 2 comprises a main body and a pressure-resistant fragment provided on the main body and against the light board 1.

As seen from the above description, the pressure-resistant fragment not only allows the connecting platform to be electrically connected to the light board, but also makes the snap-joint structure more stable.

Furthermore, the AC input end 3 and the pressure-resistant fragment are conducting.
Furthermore, the AC input end 3 and the pressure-resistant fragment are screwed or snap-joined.

As seen from the above description, the connections between the AC input end and the connecting platform vary, specifically including snap joining, welding, screwing and extrusion connecting, and preferably screwing or snap joining. Any way of connection is feasible if only the AC input end and the pressure-resistant fragment inside the connecting platform can be conducting.

Furthermore, the material of the pressure-resistant fragment is copper.
As seen from the above description, copper is a material excellent in electrical conductivity and elasticity and suitable to make the pressure-resistant fragment.

### Embodiment 1

As shown in FIG. 1 to FIG. 3 in Embodiment 1 of the present utility model: as shown in FIG. 1, an LED light, comprising a light board 1 and further comprising a connecting platform 2 and an AC input end 3, wherein the connecting platform 2 and the light board 1 are snap-joined and conducting, and the AC input end 3 is connected to the connecting platform 2 in the direction perpendicular to the light board 1 and conducting with the connecting platform 2.

In combination with FIG. 1 to FIG. 3, the profile of the connecting platform 2 is of a convex shape, the light board 1 is provided with a through-hole having a cross-section slightly larger than the cross-section of the convex section 6 of the connecting platform, and the connecting platform is provided with snap joint portions 7 used for preventing the convex section 6 of the connecting platform from coming off from the through-hole.

As shown in FIG. 2, the number of the snap joint portions 7 is two or four, and the snap joint portions 7 are provided on opposite sides of the convex section 6 of the connecting platform. During the process of assembling, the convex section 6 of the connecting platform and the snap joint portions 7 pass through the through-hole, and then the snap joint portions 7 will stretch out to clamp the light board 1 so as to prevent the convex section 6 of the connecting platform from coming off from the through-hole. During the process of disassembling, the snap joint portions 7 are pressed so as to eject the convex section 6 of the connecting platform from the through-hole. Such an assembling way is simple and reliable and also makes the disassembling very simple and convenient, so it is conductive to the reduction of processing costs.

The connecting platform 2 comprises a main body and a pressure-resistant fragment provided on the main body and against the light board 1, the AC input end 3 and the pressure-resistant fragment are conducting, and the AC input end 3 has a variety of specific forms such as terminal, ejector, spring or other forms of connectors. Preferably, the AC input end 3 and the pressure-resistant fragment are screwed or snap-joined.

Furthermore, the material of the pressure-resistant fragment is copper.

### Embodiment 2

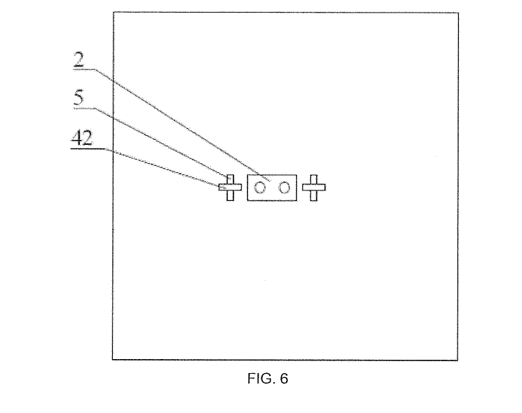

As shown in FIG. 4 to FIG. 6, further improvements on specific forms of the snap joint between the connecting platform 2 and the light board 1 have been made in Embodiment 2 based on Embodiment 1, specifically comprising: the connecting platform is provided with a snap joint part 4, and the light board 1 is provided with a snap joint seat adapted to the snap joint part 4. In this embodiment, the snap joint part 4 comprises a base 41 provided on the connecting platform 2 and an I-shaped hook 42 rotatably provided on the base 41; the snap joint seat is a linear slot 5. As shown in FIG. 4 and FIG. 5, during the process of assembling, firstly, the hook 42 is aligned with the linear slot 5 and partially passes through the linear slot 5, and then the hook 42 is rotated so that the portion of the hook 42 passing through the through-hole is snap-joined with the light board 1, thus completing the assembling (as shown in FIG. 6); such a way of assembling is simple and reliable and also makes the disassembling very simple and convenient.

To sum up, as to the LED light disclosed in the present utility model, the light board and the connecting platform are fixed with a snap joint structure instead of tin soldering, and the AC input end is connected to the connecting platform in the direction perpendicular to the light board so that the three parts of the light board, the connecting platform and the AC input end of the LED light are convenient to assemble and disassemble and easy to maintain which is conducive to the reduction of use costs.

The foregoing are only embodiments of the present utility model and not intended to limit the patent scope of the utility model. Any equivalent changes made based on the specification and the drawings of the present utility model, or direct or indirect application in related technical fields are likewise included in the patent protection scope of the utility model.

What is claimed is:

1. An LED light, comprising a light board, characterized in that, further comprising a connecting platform and an AC input end, wherein the connecting platform and the light board are snap-joined and conducting, and the AC input end is connected to the connecting platform in the direction perpendicular to the light board and conducting with the connecting platform.

2. The LED light as claimed in claim 1, characterized in that the profile of the connecting platform is of a convex shape, the light board is provided with a through-hole having a cross-section slightly larger than the cross-section of the convex section of the connecting platform, and the convex section of the connecting platform is provided with snap joint portions used for preventing the convex section of the connecting platform from coming off from the through-hole.

3. The LED light as claimed in claim 2, characterized in that the number of the snap joint portions is two or four.

4. The LED light as claimed in claim 3, characterized in that the snap joint portions are provided on opposite sides of the convex section of the connecting platform.

5. The LED light as claimed in claim 1, characterized in that the connecting platform is provided with a snap joint part, and the light board is provided with a snap joint seat adapted to the snap joint part.

6. The LED light as claimed in claim 5, characterized in that the snap joint part comprises a base provided on the connecting platform and an I-shaped hook rotatably provided on the base; the snap joint seat is a linear slot.

7. The LED light as claimed in claim 1, characterized in that the connecting platform comprises a main body and a pressure-resistant fragment provided on the main body and against the light board.

8. The LED light as claimed in claim 2, characterized in that the connecting platform comprises a main body and a pressure-resistant fragment provided on the main body and against the light board.

9. The LED light as claimed in claim 3, characterized in that the connecting platform comprises a main body and a pressure-resistant fragment provided on the main body and against the light board.

10. The LED light as claimed in claim 4, characterized in that the connecting platform comprises a main body and a pressure-resistant fragment provided on the main body and against the light board.

11. The LED light as claimed in claim 5, characterized in that the connecting platform comprises a main body and a pressure-resistant fragment provided on the main body and against the light board.

12. The LED light as claimed in claim 6, characterized in that the connecting platform comprises a main body and a pressure-resistant fragment provided on the main body and against the light board.

13. The LED light as claimed in claim 7, characterized in that the AC input end and the pressure-resistant fragment are conducting.

14. The LED light as claimed in claim 8, characterized in that the AC input end and the pressure-resistant fragment are screwed or snap-joined.

15. The LED light as claimed in claim 8, characterized in that the material of the pressure-resistant fragment is copper.

16. The LED light as claimed in claim 9, characterized in that the material of the pressure-resistant fragment is copper.
